(19) United States
(12) Patent Application Publication
(10) Pub. No.: US 2016/0333973 A1
(43) Pub. Date: Nov. 17, 2016

(54) PLANETARY GEAR TRAIN OF AUTOMATIC TRANSMISSION FOR VEHICLES

(71) Applicant: Hyundai Motor Company, Seoul (KR)

(72) Inventors: Wonmin CHO, Hwaseong-si (KR); Jae Chang KOOK, Hwaseong-si (KR); Myeong Hoon NOH, Seongnam-si (KR); Seongwook JI, Ansan-si (KR); Kangsoo SEO, Yongin-si (KR); Seong Wook HWANG, Gunpo-si (KR)

(73) Assignee: Hyundai Motor Company, Seoul (KR)

(21) Appl. No.: 14/923,196

(22) Filed: Oct. 26, 2015

(30) Foreign Application Priority Data
May 13, 2015 (KR) 10-2015-0066903

(51) Int. Cl. F16H 3/66

(52) U.S. Cl. CPC F16H 3/66; F16H 2200/0069; F16H 2200/2012; F16H 2200/2046

(57) ABSTRACT

A planetary gear train of an automatic transmission for vehicles may include an input shaft configured to receive power of an engine, an output shaft configured to output shifted power of the engine, a first planetary gear set, a second planetary gear set, a third planetary gear set, a fourth planetary gear set, a first rotating shaft selectively connected to a transmission housing, a second rotating shaft, a third rotating shaft selectively connected to the transmission housing, a fourth rotating shaft directly connected to the input shaft to be continuously operated as an input element, a fifth rotating shaft, a sixth rotating shaft, a seventh rotating shaft selectively connected to the input shaft simultaneously with being selectively connected to the fifth and sixth rotating shafts, an eighth rotating shaft directly connected to the output shaft simultaneously with being selectively connected to the sixth rotating shaft, and six friction elements.

### CROSS-REFERENCE TO RELATED APPLICATION

The present application claims priority to Korean Patent Application No. 10-2015-0066903 filed May 13, 2015, the entire contents of which is incorporated herein for all purposes by this reference.

### BACKGROUND OF THE INVENTION

1. Field of the Invention

The present invention relates to an automatic transmission for vehicles, and more particularly, to a planetary gear train of an automatic transmission for vehicles capable of improving power delivery performance and fuel efficiency by implementing advance 10 speed with a minimum configuration.

2. Description of the Related Art

The recent rise of oil price becomes a factor of making car makers more competitive for improving fuel efficiency.

For this purpose, studies to reduce a weight and improve fuel efficiency by downsizing an engine have been conducted and studies to secure drivability and fuel efficiency competitiveness, by providing automatic transmissions capable of achieving multiple speed stages, have been conducted.

However, as the number of shift stages is increased, the number of parts of the automatic transmission is increased, and as a result the automatic transmission may be difficult to mount, the manufacturing cost and weight may be increased, and power transmission efficiency may be deteriorated.

Therefore, to increase the improvement effect of fuel efficiency by providing multiple speed stages, it is important to develop a planetary gear train which may achieve maximum efficiency with a small number of parts.

In connection with this, 8-speed and 9-speed automatic transmissions tend to be implemented in recent and the research and development for a planetary gear train which may implement a shift stage higher than that of the 8-speed and 9-speed automatic transmissions has been actively conducted.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a planetary gear train of an automatic transmission for vehicles capable of improving power delivery performance and improving fuel consumption depending on multi -staging by implementing an advance 10-speed and reverse 1-speed shift stage with a minimum configuration and enhancing driving stability of vehicles by using an operation point in a low rotating speed area of an engine.

According to various aspects of the present invention, a planetary gear train of an automatic transmission for vehicles may include an input shaft configured to receive power of an engine, an output shaft configured to output shifted power of the engine, a first planetary gear set including a first sun gear, a first planetary carrier, and a first ring gear, a second planetary gear set including a second sun gear, a second planetary carrier, and a second ring gear, a third planetary gear set including a third sun gear, a third planetary carrier, and a third ring gear, a fourth planetary gear set including a fourth sun gear, a fourth planetary carrier, and a fourth ring gear, a first rotating shaft including the first and second sun gears and selectively connected to a transmission housing, a second rotating shaft including the first planetary carrier, the third planetary carrier, and the fourth ring gear, a third rotating shaft including the first ring gear and selectively connected to the transmission housing, a fourth rotating shaft including the second planetary carrier and directly connected to the input shaft to be continuously operated as an input element, a fifth rotating shaft including the second ring gear and the third sun gear, a sixth rotating shaft including the third ring gear, a seventh rotating shaft including the fourth sun gear and selectively connected to the input shaft simultaneously with being selectively connected to the fifth and sixth rotating shafts, an eighth rotating shaft including the fourth planetary carrier and directly connected to the output shaft simultaneously with being selectively connected to the sixth rotating shaft, and six friction elements disposed between the rotating shafts, at least a portion of which selectively connect between the rotating shafts and the transmission housing.

Each of the first, second, third, and fourth planetary gear sets may be a single pinion planetary gear set.

The first, second, third, and fourth planetary gear sets may be sequentially disposed from an engine side.

The six friction elements may include a first clutch interposed between the input shaft and the seventh rotating shaft, a second clutch interposed between the sixth rotating shaft and the eighth rotating shaft, a third clutch interposed between the fifth rotating shaft and the seventh rotating shaft, a fourth clutch interposed between the sixth rotating shaft and the seventh rotating shaft, a first brake interposed between the first rotating shaft and the transmission housing, and a second brake interposed between the third rotating shaft and the transmission housing.

Shift stages implemented by the selective operation of the six friction elements may include an advance first shift stage implemented by a simultaneous operation of the first clutch and the first and second brakes, an advance second shift stage implemented by a simultaneous operation of the third clutch and the first and second brakes, an advance third shift stage implemented by a simultaneous operation of the first and third clutches and the second brake, an advance fourth shift stage implemented by a simultaneous operation of the second and third clutches and the second brake, an advance fifth shift stage implemented by a simultaneous operation of the first and second clutches and the second brake, an advance sixth shift stage implemented by a simultaneous operation of the first and fourth clutches and the second brake, an advance seventh shift stage implemented by a simultaneous operation of the first, third, and fourth clutches, an advance eighth shift stage implemented by a simultaneous operation of the first and fourth clutches and the first brake, an advance ninth shift stage implemented by a simultaneous operation of the first and second clutches and the first brake, an advance tenth shift stage implemented by a simultaneous operation of the second and third clutches and the first brake, and a reverse shift stage implemented by a simultaneous operation of the fourth clutch and the first and second brakes.

According to various aspects of the present invention, a planetary gear train of an automatic transmission for vehicles may include an input shaft configured to receive power of an engine, an output shaft configured to output shifted power of the engine, a first planetary gear set including a first sun gear, a first planetary carrier, and a first ring gear, a second planetary gear set including a second sun gear, a second planetary carrier, and a second ring gear, a third planetary gear set including a third sun gear, a third planetary carrier, and a third ring gear, a fourth planetary gear set including a fourth sun gear, a fourth planetary carrier, and a fourth ring gear, a first clutch selectively connecting the input shaft and the fourth sun gear, a second clutch selectively connecting the third ring gear and the fourth planetary carrier, a third clutch selectively connecting the third sun gear and the fourth sun gear, a fourth clutch selectively connecting the third ring gear and the fourth sun gear, a first brake selectively connecting first sun gear and a transmission housing, and a second brake selectively connecting the first ring gear and the transmission housing, in which the input shaft may be directly connected to the second planetary carrier, the input shaft may be directly connected to the fourth planetary carrier, the first sun gear and the second sun gear may be directly connected to each other, the first planetary carrier, the third planetary carrier, the fourth ring gear may be directly connected to one another, and the second ring gear and the third sun gear may be directly connected to each other.

According to various embodiments of the present invention, it is possible to improve the power delivery performance and the fuel efficiency by implementing the advance 10-speed shift stages by combining four planetary gear sets configured of the simple planetary gear set using six friction elements.

Further, it is possible to greatly improve the driving stability by implementing the shift stage suited for the rotating speed of the engine by multi-staging the automatic transmission.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of an exemplary planetary gear train according to the present invention.

FIG. 2 is an operation table for each shift stage of each friction element applied to the exemplary planetary gear train according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

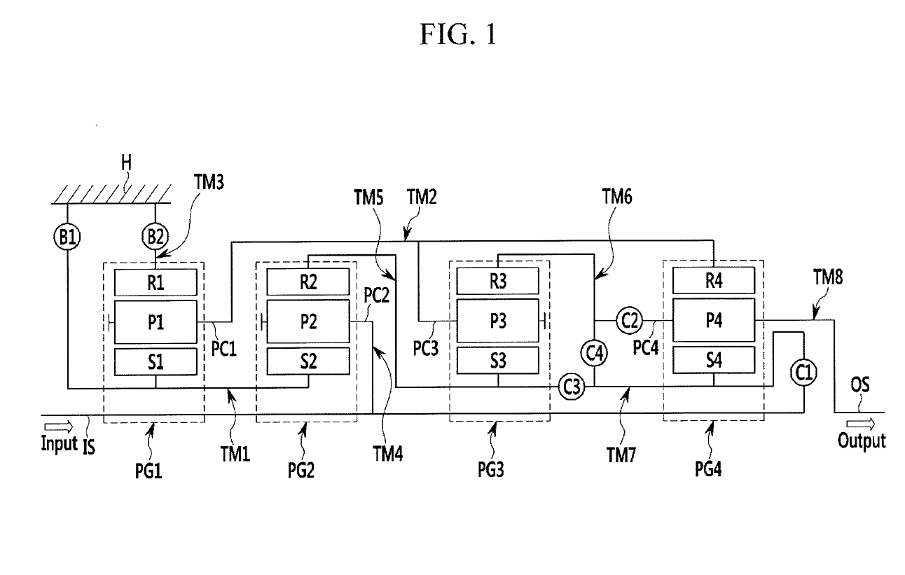

FIG. 1 is a configuration diagram of a planetary gear train according to various embodiments of the present invention.

Referring to FIG. 1, a planetary gear train according to various embodiments of the present invention includes first, second, third, and fourth planetary gear sets PG1, PG2, PG3, and PG4 which are disposed on the same axis line, an input shaft IS, an output shaft OS, eight rotating shafts TM1 to TM8 which directly connect each of the rotating elements of the first, second, third, fourth planetary gear sets PG1, PG2, PG3, and PG4 to each other, 6 friction elements C1 to C4 and B1 to B2, and a transmission housing H.

Accordingly, rotating power input from the input shaft IS is shifted by a mutual supplement operation of the first, second, third, fourth planetary gear sets PG1, PG2, PG3, and PG4 and output through the output shaft OS.

Further, each simple planetary gear set is disposed in an order of the first, second, third, fourth planetary gear sets PG1, PG2, PG3, and PG4 from an engine side.

The input shaft IS is an input member and receives rotating power from a crank shaft of an engine while the rotating power is subjected to torque conversion by a torque converter.

The output shaft OS is an output member and transfers the shifted driving torque to a driving shaft through a differential apparatus

The first planetary gear set PG1 which is a single pinion planetary gear set is configured to include a first sun gear S1, a first planetary carrier PC1 supporting a first pinion P1 externally engaged with the first sun gear S1 and a first ring gear R1 internally engaged with the first pinion P1 as a rotating element.

The second planetary gear set PG2 which is the single pinion planetary gear set includes a second sun gear S2, a second planetary carrier PC2 supporting a second pinion P2 externally engaged with the second sun gear S2, and a second ring gear R2 internally engaged with the second pinion P2.

The third planetary gear set PG3 which is the single pinion planetary gear set includes a third sun gear S3, a third planetary carrier PC3 supporting a third pinion P3 externally engaged with the third sun gear S3, and a third ring gear R3 internally engaged with the third pinion P3.

The fourth planetary gear set PG4 which is the single pinion planetary gear set includes a fourth sun gear S4, a fourth planetary carrier PC4 supporting a fourth pinion P4 externally engaged with the fourth sun gear S4, and a fourth ring gear R4 internally engaged with the fourth pinion P4.

Further, the first, second, third, and fourth planetary gear sets PG1, PG2, PG3, and PG4 are directly connected to at least one rotating element to be operated while holding a total of eight rotating shafts TM1 to TM8.

A configuration of the eight rotating shafts TM1 to TM8 will be described as follows.

The first rotating shaft TM1 is configured to include the first and second sun gears S1 and S2 and is selectively connected to a transmission housing H.

The second rotating shaft TM2 is configured to include the first planetary carrier PC1, the third planetary carrier PC3, and the fourth ring gear R4.

The third rotating shaft TM3 is configured to include the first ring gear R1 and is selectively connected to the transmission housing H.

The fourth rotating shaft TM4 is configured to include the second planetary carrier PC2 and is directly connected to the input shaft IS to be always operated as an input element.

The fifth rotating shaft TM5 is configured to include the second ring gear R2 and the third sun gear S3.

The sixth rotating shaft TM6 is configured to include the third ring gear R3.

The seventh rotating shaft TM7 is configured to include the fourth sun gear S4 and is selectively connected to the input shaft IS while being selectively connected to the fifth and sixth rotating shafts TM5 and TM6.

The eighth rotating shaft TM8 is configured to include the fourth planetary carrier PC4 and is always operated as an output element by being directly connected to the output shaft OS while being selectively connected to the sixth rotating shaft TM6.

Further, among the rotating shafts TM1 to TM8, a part selectively connected between the rotating shafts is provided with four clutches C1, C2, C3, and C4 which are the friction elements.

Further, among the rotating shafts TM1 to TM8, a part selectively connected to the transmission housing H is provided with two brakes B1 and B2 which are the friction elements.

A disposition position of the six friction elements C1 to C4 and B1 to B2 will be described as follows.

The first clutch C1 is interposed between the input shaft IS and the seventh rotating shaft TM7 and thus the first input shaft IS and the seventh rotating shaft TM7 are selectively integrated.

The second clutch C2 is interposed between the sixth rotating shaft TM6 and the eighth rotating shaft TM8 and thus the sixth rotating shaft TM6 and the eighth rotating shaft TM8 are selectively integrated.

The third clutch C3 is interposed between the fifth rotating shaft TM5 and the seventh rotating shaft TM7 and thus the fifth rotating shaft TM5 and the seventh rotating shaft TM7 are selectively integrated.

The fourth clutch C4 is interposed between the sixth rotating shaft TM6 and the seventh rotating shaft TM7 and thus the sixth rotating shaft TM6 and the seventh rotating shaft TM7 are selectively integrated.

The first brake B1 is disposed between the first rotating shaft TM1 and the transmission housing H and thus the first rotating shaft TM1 may be operated as a selective fixed element.

The second brake B2 is interposed between the third rotating shaft TM3 and the transmission housing H and thus the third rotating shaft TM3 may be operated as a selective fixed element.

As described above, each friction element which is configured of the first, second, third, and fourth clutches C1, C2, C3, and C4 and the first and second brakes B1 and B2 may be configured of a multi-plate type hydraulic friction coupling unit which is friction coupled by an oil pressure.

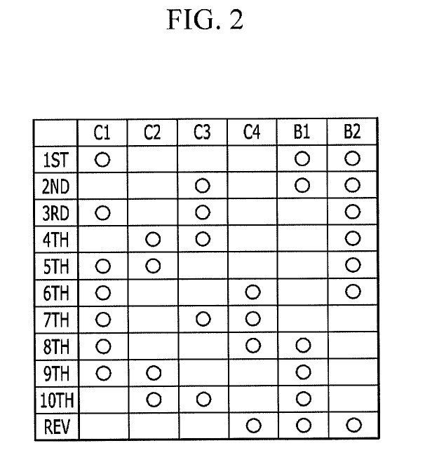

FIG. 2 is an operation table for each shift stage of each friction element applied to the planetary gear train according to various embodiments of the present invention.

As illustrated in FIG. 2, the planetary gear train according to various embodiments of the present invention is shifted while the three friction elements are operated at each shift stage.

An advance 1-speed shift stage 1ST is achieved by simultaneously operating the first clutch C1 and the first and second brakes B1 and B2.

An advance 2-speed shift stage 2ND is achieved by simultaneously operating the third clutch C3 and the first and second brakes B1 and B2.

An advance 3-speed shift stage 3RD is achieved by simultaneously operating the first and third clutches C1 and C3 and the second brake B2.

An advance 4-speed shift stage 4TH is achieved by simultaneously operating the second and third clutches C2 and C3 and the second brake B2.

An advance 5-speed shift stage 5TH is achieved by simultaneously operating the first and second clutches C1 and C2 and the second brake B2.

An advance 6-speed shift stage 6TH is achieved by simultaneously operating the first and fourth clutches C1 and C4 and the second brake B2.

An advance 7-speed shift stage 7TH is achieved by simultaneously operating the first, third, and fourth clutches C1, C3, and C4.

An advance 8-speed shift stage 8TH is achieved by simultaneously operating the first and fourth clutches C1 and C4 and the first brake B1.

An advance 9-speed shift stage 9TH is achieved by simultaneously operating the first and second clutches C1 and C2 and the first brake B1.

An advance 10-speed shift stage 10TH is achieved by simultaneously operating the second and third clutches C2 and C3 and the first brake B1.

A reverse shift stage REV is achieved by simultaneously operating the fourth clutch C4 and the first and second brakes B1 and B2.

The shifting process will be described in detail below.

When the first clutch C1 and the first and second brakes B1 and B2 are simultaneously operated at the advance 1-speed shift stage 1ST, an input is made to the fourth and seventh rotating shafts TM4 and TM7 in the state in which the input shaft IS is connected to the seventh rotating shaft TM7 and the advance 1-speed shifting is made while the first and third rotating shafts TM1 and TM3 are operated as the fixed element.

When the third clutch C3 and the first and second brakes B1 and B2 are simultaneously operated at the advance 2-speed shift stage 2ND, an input is made to the fourth rotating shaft TM4 in the state in which the fifth rotating shaft TM5 is connected to the seventh rotating shaft TM7 and the advance 2-speed shifting is made while the first and third rotating shafts TM1 and TM3 are operated as the fixed element.

When the first and third clutches C1 and C3 and the second brake B2 are simultaneously operated at the advance 3-speed shift stage 3RD, an input is made to the fourth rotating shaft TM4 in the state in which the input shaft IS is connected to the seventh rotating shaft TM7 and the fifth rotating shaft TM5 is connected to the seventh rotating shaft TM7 and the advance 3-speed shifting is made while the third rotating shaft TM3 is operated as the fixed element.

When the second and third clutches C2 and C3 and the second brake B2 are simultaneously operated at the advance 4-speed shift stage 4TH, an input is made to the fourth rotating shaft TM4 in the state in which the fifth rotating shaft TM5 is connected to the seventh rotating shaft TM7 and the sixth rotating shaft TM6 is connected to the eighth rotating shaft TM8 and the advance 4-speed shifting is made while the third rotating shaft TM3 is operated as the fixed element.

When the first and second clutches C1 and C2 and the second brake B2 are simultaneously operated at the advance 5-speed shift stage 5TH, an input is made to the fourth and seventh rotating shafts TM4 and TM7 in the state in which the input shaft IS is connected to the seventh rotating shaft TM7 and the sixth rotating shaft TM6 is connected to the eighth rotating shaft TM8 and the advance 5-speed shifting is made while the third rotating shaft TM3 is operated as the fixed element.

When the first and fourth clutches C1 and C4 and the second brake B2 are simultaneously operated at the advance 6-speed shift stage 6TH, an input is made to the fourth and seventh rotating shafts TM4 and TM7 in the state in which the input shaft IS is connected to the seventh rotating shaft TM7 and the sixth rotating shaft TM6 is connected to the seventh rotating shaft TM7 and the advance 6-speed shifting is made while the third rotating shaft TM3 is operated as the fixed element.

When the first, third, and fourth clutches C1, C3, and C4 are simultaneously operated at the advance 7-speed shift stage 7TH, an input is made to the fourth and seventh rotating shafts TM4 and TM7 in the state in which the input shaft IS is connected to the seventh rotating shaft TM7 and the seventh rotating shaft TM7 is connected to the fifth and sixth rotating shafts TM5 and TM6 and the advance 7-speed shifting is made to output the input itself while all the rotating shafts are in the direct connection state.

When the first and fourth clutches C1 and C4 and the first brake B1 are simultaneously operated at the advance 8-speed shift stage 8TH, an input is made to the fourth and seventh rotating shafts TM4 and TM7 in the state in which the input shaft IS is connected to the seventh rotating shaft TM7 and the sixth rotating shaft TM6 is connected to the seventh rotating shaft TM7 and the advance 8-speed shifting is made while the first rotating shaft TM1 is operated as the fixed element.

When the first and second clutches C1 and C2 and the first brake B1 are simultaneously operated at the advance 9-speed shift stage 9TH, an input is made to the fourth rotating shaft TM4 in the state in which the input shaft IS is connected to the seventh rotating shaft TM7 and the sixth rotating shaft TM6 is connected to the eighth rotating shaft TM8 and the advance 9-speed shifting is made while the first rotating shaft TM1 is operated as the fixed element.

When the second and third clutches C2 and C3 and the first brake B1 are simultaneously operated at the advance 10-speed shift stage 10TH, an input is made to the fourth rotating shaft TM4 in the state in which the fifth rotating shaft TM5 is connected to the seventh rotating shaft TM7 and the sixth rotating shaft TM6 is connected to the eighth rotating shaft TM8 and the advance 10-speed shifting is made while the first rotating shaft TM1 is operated as the fixed element.

When the fourth clutch C4 and the first and second brakes B1 and B2 are simultaneously operated at the reverse shift stage REV, an input is made to the fourth rotating shaft TM4 in the state in which the sixth rotating shaft TM6 is connected to the seventh rotating shaft TM7 and the reverse shifting is made while the first and third rotating shafts TM1 and TM3 are operated as the fixed element.

As described above, the planetary gear train according to various embodiments of the present invention may realize the advance 10-speed shift stage and the reverse 1-speed shift stage by performing the operation control of the fourth clutches C1, C2, C3, and C4 and the two brakes B1 and B2 on the fourth planetary gear sets PG1, PG2, PG3, and PG4.

Therefore, the planetary gear train according to the various embodiments of the present invention may improve the power delivery efficiency and the fuel efficiency by multi-staging the automatic transmission.

Further, it is possible to greatly improve the driving stability by implementing the shift stage suited for the rotating speed of the engine by multi-staging the automatic transmission.

Further, it is possible to minimize the number of non-operated friction elements to reduce the friction drag loss by operating three friction elements for each shift stage, thereby improving the power delivery efficiency and the fuel efficiency.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A planetary gear train of an automatic transmission for vehicles, comprising:
an input shaft configured to receive power of an engine;
an output shaft configured to output shifted power of the engine;
a first planetary gear set including a first sun gear, a first planetary carrier, and a first ring gear;
a second planetary gear set including a second sun gear, a second planetary carrier, and a second ring gear;
a third planetary gear set including a third sun gear, a third planetary carrier, and a third ring gear;
a fourth planetary gear set including a fourth sun gear, a fourth planetary carrier, and a fourth ring gear;
a first rotating shaft including the first and second sun gears and selectively connected to a transmission housing;
a second rotating shaft including the first planetary carrier, the third planetary carrier, and the fourth ring gear;
a third rotating shaft including the first ring gear and selectively connected to the transmission housing;
a fourth rotating shaft including the second planetary carrier and directly connected to the input shaft to be continuously operated as an input element;
a fifth rotating shaft including the second ring gear and the third sun gear;
a sixth rotating shaft including the third ring gear;
a seventh rotating shaft including the fourth sun gear and selectively connected to the input shaft simultaneously with being selectively connected to the fifth and sixth rotating shafts;
an eighth rotating shaft including the fourth planetary carrier and directly connected to the output shaft simultaneously with being selectively connected to the sixth rotating shaft; and
six friction elements disposed between the rotating shafts, at least a portion of which selectively connect between the rotating shafts and the transmission housing.

2. The planetary gear train of claim 1, wherein each of the first, second, third, and fourth planetary gear sets comprises a single pinion planetary gear set.

3. The planetary gear train of claim 1, wherein the first, second, third, and fourth planetary gear sets are sequentially disposed from an engine side.

4. The planetary gear train of claim 2, wherein the first, second, third, and fourth planetary gear sets are sequentially disposed from an engine side.

5. The planetary gear train of claim 1, wherein the six friction elements include:
a first clutch interposed between the input shaft and the seventh rotating shaft;
a second clutch interposed between the sixth rotating shaft and the eighth rotating shaft;
a third clutch interposed between the fifth rotating shaft and the seventh rotating shaft;
a fourth clutch interposed between the sixth rotating shaft and the seventh rotating shaft;
a first brake interposed between the first rotating shaft and the transmission housing; and
a second brake interposed between the third rotating shaft and the transmission housing.

6. The planetary gear train of claim 5, wherein shift stages implemented by the selective operation of the six friction elements include:
an advance first shift stage implemented by a simultaneous operation of the first clutch and the first and second brakes;
an advance second shift stage implemented by a simultaneous operation of the third clutch and the first and second brakes;
an advance third shift stage implemented by a simultaneous operation of the first and third clutches and the second brake;
an advance fourth shift stage implemented by a simultaneous operation of the second and third clutches and the second brake;
an advance fifth shift stage implemented by a simultaneous operation of the first and second clutches and the second brake;
an advance sixth shift stage implemented by a simultaneous operation of the first and fourth clutches and the second brake;
an advance seventh shift stage implemented by a simultaneous operation of the first, third, and fourth clutches;
an advance eighth shift stage implemented by a simultaneous operation of the first and fourth clutches and the first brake;
an advance ninth shift stage implemented by a simultaneous operation of the first and second clutches and the first brake;
an advance tenth shift stage implemented by a simultaneous operation of the second and third clutches and the first brake; and
a reverse shift stage implemented by a simultaneous operation of the fourth clutch and the first and second brakes.

7. A planetary gear train of an automatic transmission for vehicles, comprising:
an input shaft configured to receive power of an engine;
an output shaft configured to output shifted power of the engine;
a first planetary gear set including a first sun gear, a first planetary carrier, and a first ring gear;
a second planetary gear set including a second sun gear, a second planetary carrier, and a second ring gear;
a third planetary gear set including a third sun gear, a third planetary carrier, and a third ring gear;
a fourth planetary gear set including a fourth sun gear, a fourth planetary carrier, and a fourth ring gear;
a first clutch selectively connecting the input shaft and the fourth sun gear;
a second clutch selectively connecting the third ring gear and the fourth planetary carrier;
a third clutch selectively connecting the third sun gear and the fourth sun gear;
a fourth clutch selectively connecting the third ring gear and the fourth sun gear;
a first brake selectively connecting first sun gear and a transmission housing; and
a second brake selectively connecting the first ring gear and the transmission housing,
wherein the input shaft is directly connected to the second planetary carrier,
the input shaft is directly connected to the fourth planetary carrier,
the first sun gear and the second sun gear are directly connected to each other,
the first planetary carrier, the third planetary carrier, the fourth ring gear are directly connected to one another, and
the second ring gear and the third sun gear are directly connected to each other.

8. The planetary gear train of claim 7, wherein each of the first, second, third, and fourth planetary gear sets comprises a single pinion planetary gear set.

9. The planetary gear train of claim 7, wherein the first, second, third, and fourth planetary gear sets are sequentially disposed from an engine side.

10. The planetary gear train of claim 8, wherein the first, second, third, and fourth planetary gear sets are sequentially disposed from an engine side.

11. The planetary gear train of claim 6, wherein shift stages implemented by the selective operation of the six friction elements include:
an advance first shift stage implemented by a simultaneous operation of the first clutch and the first and second brakes;
an advance second shift stage implemented by a simultaneous operation of the third clutch and the first and second brakes;
an advance third shift stage implemented by a simultaneous operation of the first and third clutches and the second brake;
an advance fourth shift stage implemented by a simultaneous operation of the second and third clutches and the second brake;
an advance fifth shift stage implemented by a simultaneous operation of the first and second clutches and the second brake;
an advance sixth shift stage implemented by a simultaneous operation of the first and fourth clutches and the second brake;
an advance seventh shift stage implemented by a simultaneous operation of the first, third, and fourth clutches;
an advance eighth shift stage implemented by a simultaneous operation of the first and fourth clutches and the first brake;
an advance ninth shift stage implemented by a simultaneous operation of the first and second clutches and the first brake;
an advance tenth shift stage implemented by a simultaneous operation of the second and third clutches and the first brake; and
a reverse shift stage implemented by a simultaneous operation of the fourth clutch and the first and second brakes.
